(19) United States
(12) Patent Application Publication
(10) Pub. No.: US 2025/0309731 A1
(43) Pub. Date: Oct. 2, 2025

(54) METHOD FOR DETERMINING THE EXPANSION OF A ROTOR AND ASSOCIATED DEVICE

(71) Applicants: SKF Magnetic Mechatronics, Saint-Marcel (FR); SKF Canada Limited, Scarborough (CA)

(72) Inventors: Jinyi XIE, Hébécourt (FR); Nicholas FALCONAR, Calgary (CA); Lakdar SADI-HADDAD, Nogent sur Marne (FR); Joaquim DA SILVA, Sennely (FR)

(21) Appl. No.: 19/084,959

(22) Filed: Mar. 20, 2025

(30) Foreign Application Priority Data
Mar. 27, 2024 (FR) FR2403079

(51) Int. Cl. H02K 11/21; F16C 32/04; G01D 5/20

(52) U.S. Cl. CPC H02K 11/21; F16C 32/0446; G01D 5/20

(57) ABSTRACT

A device for determining expansion of a rotor (3) of an electric machine, where the rotor is supported by at least one magnetic bearing (4, 5). The device includes an inductive position sensor (7, 8) measuring a position of the rotor (3), a first determining means (11), a second determining means, and a third determining means (12). The first determining means (11) determines a gap width (J) separating the rotor from said inductive position sensor. The second determining means determines the value of a current representative of the power being supplied to the inductive position sensor. The third determining means (12) determines the value of the expansion of the rotor (3).

### CROSS-REFERENCE TO RELATE APPLICATION

This application claims priority to French Application No. FR2403079, filed Mar. 27, 2024, the entirety of which is hereby incorporated by reference.

### FIELD

The present disclosure relates to electric machines comprising a rotor supported by magnetic bearings and particularly to determining the expansion of the rotor.

The present disclosure more particularly relates to a method for determining the expansion of a rotor and to a device for determining the expansion of a rotor.

### BACKGROUND

Magnetic bearings are used in various rotary machines such as electric motors, compressors, turbines, or the like to maintain the axial and/or radial positions of a rotor by means of magnetic fields acting on the rotor of the machine.

Inductive position sensors are used in magnetic bearing controllers (MBCs) to measure rotor position.

The measurements delivered by the position sensors are used to control the magnetic bearings.

Rotary machines may further have an inductive position sensor placed at each end of the rotor and a processing unit for determining a variation in rotor length or axial expansion of the rotor based on the measurements delivered by the inductive position sensors placed at the ends of the rotor.

Axial expansion is for example caused by centrifugal force during rotation of the rotor and temperature.

It is advantageous to determine the axial expansion of the rotor so as to guarantee correct operation of the machine.

Installation of the inductive position sensors and processing unit dedicated to determining the axial expansion of the rotor requires installation space to be provided in the machine.

It is also advantageous to determine a variation in rotor diameter or radial expansion of the rotor so as to guarantee correct operation of the machine.

### SUMMARY

Therefore, the present disclosure aims to determine the axial or radial expansion of the rotor without addition of sensors and of a dedicated processing unit.

According to one aspect, a method for determining, using an inductive position sensor, the expansion of a rotor of an electric machine is provided, the rotor being supported by at least one magnetic bearing, the inductive position sensor measuring the position of the rotor.

The method comprises:
in a calibrating phase following installation of the rotor in the magnetic bearing:
   determining a gap width separating the rotor from said inductive position sensor, said gap width being equal to a reference value of the gap width, and
   determining the value of a current representative of the power being supplied to the inductive position sensor when the gap width separating the rotor from said inductive position sensor is equal to the reference value of the gap width, the value of said current being a reference value of said current,
in a monitoring phase following at least one usage phase of the electric machine:
   determining the present value of said current,
the method further comprising determining the value of the expansion of the rotor based on the reference value of said current, on the present value of said current and on the reference value of the gap width.

The method allows the value of the axial or radial expansion of the rotor to be determined without addition of position sensors and of means for processing the signals delivered by said sensors dedicated to determining said expansion.

The method employs an inductive position sensor, which is conventionally already present in the electric machine to control the magnetic bearings, to determine the expansion of the rotor.

By “using the electric machine”, what is meant is a usage phase of the electric machine to perform the task for which it was designed, for example to compress a gas when the electric machine is a motorized compressor or a cryogenic compressor, to pump a fluid when the electric machine is a pump, to generate torque when the electric machine is a turbine of a power plant, to generate electrical power when the machine is a generator of a power plant, to store energy when the electric machine is a flywheel, or to machine material when the electric machine is a machine tool.

The electric machine may be a high-speed motor. It may be implemented in space technology.

Preferably, the value of the expansion of the rotor is equal to the value of a radial expansion of the rotor, the inductive position sensor measuring the radial position of the rotor.

Advantageously, the value of the expansion of the rotor is equal to the value of an axial expansion of the rotor, the inductive position sensor measuring the axial position of the rotor.

Preferably, the current representative of the power being supplied to the inductive position sensor comprises a reactive-power-compensating current delivered by a compensating device, the reactive-power-compensating current being supplied to the inductive position sensor to compensate for the reactive power consumed by the position sensor, the determination of the value of the expansion of the rotor comprising determining the reactive-power-compensating current, the value of the expansion Vd of the rotor being determined using the following equation:

$$Vd = J ( t 0 ) - \frac{J ( t 0 ) {I}_{c} ( t 1 )}{{I}_{c} ( t 0 )}$$

where J(t0) is the reference value of the gap width, I_{C}(t0) is the reference value of the compensating current and I_{C}(t1) is the present value of the compensating current.

Advantageously, the sensor is supplied with an AC supply current delivered by an AC voltage source, the current representative of the power being supplied to the inductive position sensor comprising the quadrature component of the AC supply current, the determination of the value of the expansion of the rotor comprising determining the quadrature component of the AC supply current, the value of the expansion Vd of the rotor being determined using the following equation:

$$Vd = J ( t 0 ) - \frac{J ( t 0 ) {I}_{S\_q} ( t 1 )}{{I}_{S\_q} ( t 0 )}$$

where J(t0) is the reference value of the gap width, I_{S_q}(t0) is the reference value of the quadrature component of the AC supply current and I_{S_q}(t1) is the present value of the quadrature component of the AC supply current.

According to another aspect, the present disclosure also relates to a device for determining expansion of a rotor of an electric machine, the rotor being supported by at least one magnetic bearing.

The device comprises:
an inductive position sensor measuring a position of the rotor,
first determining means configured to determine a gap width separating the rotor from said inductive position sensor, said gap width being equal to a reference value of the gap width in a calibrating phase following installation of the rotor in the magnetic bearing,
second determining means configured to determine the value of a current representative of the power being supplied to the inductive position sensor when the gap width separating the rotor from said inductive position sensor is equal to the reference value of the gap width, the value of said current being a reference value of said current in the calibrating phase following installation of the rotor in the magnetic bearing, and to determine the value of the current representative of the power being supplied to the inductive position sensor in a monitoring phase following at least one usage phase of the electric machine, and
third determining means configured to determine the value of the expansion of the rotor based on the reference value of said current, on the present value of said current and on the value of the gap width.

Advantageously, the inductive position sensor is an inductive radial-position sensor configured to measure the radial position of the rotor, the value of the expansion of the rotor being equal to the value of a radial expansion of the rotor.

Preferably, the inductive position sensor is an inductive axial-position sensor configured to measure the axial position of the rotor, the value of the expansion of the rotor being equal to the value of an axial expansion of the rotor.

Advantageously, the current representative of the power being supplied to the inductive position sensor comprises a reactive-power-compensating current delivered by a compensating device, the reactive-power-compensating current being supplied to the inductive position sensor to compensate for the reactive power consumed by the position sensor, the second determining means being configured to determine the reference value of the compensating current in the calibrating phase, and to determine the value of the compensating current in the monitoring phase, and the third determining means being configured to determine the value of the expansion Vd of the rotor using the following equation:

$$Vd = J ( t 0 ) - \frac{J ( t 0 ) {I}_{c} ( t 1 )}{{I}_{c} ( t 0 )}$$

where J(t) is the reference value of the gap width, I_{C}(t0) is the reference value of the compensating current and I_{C}(t1) is the present value of the compensating current.

Preferably, the sensor is supplied with an AC supply current delivered by an AC voltage source, the current representative of the power being supplied to the inductive position sensor comprising the quadrature component of the AC supply current, the second determining means being configured to determine the reference value of the quadrature component of the AC supply current in the calibrating phase, and to determine the quadrature component of the AC supply current in the monitoring phase, and the third determining means being configured to determine the value of the expansion Vd of the rotor using the following equation:

$$Vd = J ( t 0 ) - \frac{J ( t 0 ) {I}_{S\_q} ( t 1 )}{{I}_{S\_q} ( t 0 )}$$

where J(t0) is the reference value of the gap width, I_{S_q}(t0) is the reference value of the quadrature component of the AC supply current and I_{S_q}(t1) is the present value of the quadrature component of the AC supply current.

### BRIEF DESCRIPTION OF THE DRAWINGS

Other advantages and features of the present disclosure will become apparent on examining the detailed descriptions of completely non-limiting embodiments. The attached drawings are described below:

FIG. 1 schematically illustrates a machine according to the present disclosure;

FIG. 2 schematically illustrates one example of a supply circuit for an inductive position sensor according to the present disclosure; and

FIG. 3 schematically illustrates one example of a method for determining the coefficient of expansion of a rotor according to the present disclosure.

### DETAILED DESCRIPTION

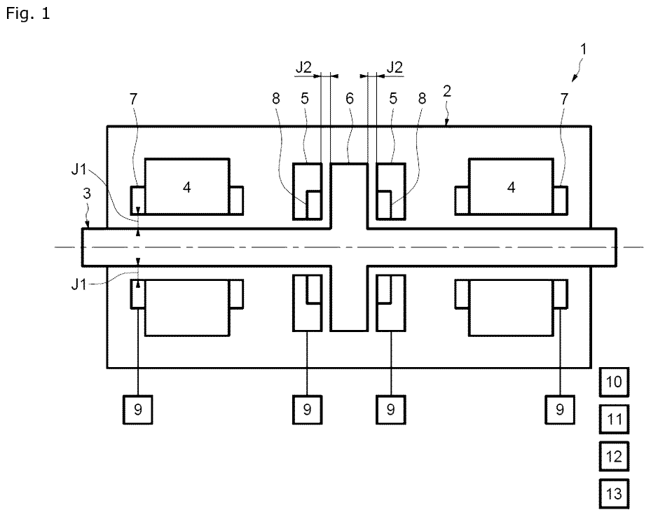

Reference will now be made to FIG. 1, which schematically shows a partial longitudinal cross section of a machine 1.

The machine 1 comprises a housing 2, a rotor 3 supported in the housing 2 by two radial active magnetic bearings 4 and an axial active bearing 5.

The radial active magnetic bearings 4 encircle the rotor 3 radially.

The rotor 3 further comprises a disc 6 axially encircled by the axial active bearing 5.

The machine 1 further comprises two inductive position sensors 7 for measuring the radial position of the rotor 3, and two inductive position sensors 8 placed on either side of the disc 5 for measuring the axial position of the rotor 3.

The measurements delivered by the inductive position sensors 6 measure the radial position of the rotor 3 and the measurements delivered by the inductive position sensors 8 measure the axial position of the rotor 3.

The machine 1 further comprises a plurality of supply circuits 9 for supplying power to the sensors 7, 8.

Each supply circuit 9 is connected to one sensor 7, 8, to supply power to said sensor 7, 8.

The supply circuit 9 may be located outside the machine 1 as shown.

As a variant, the supply circuit 9 is located inside the machine 1.

It is assumed that the rotor 3 is separated from the inductive position sensors 7 measuring the radial movement of the rotor 3 by a gap width J₁, and that the disc 6 of the rotor 3 is separated from the inductive position sensors 8 measuring the axial movement of the rotor 3 by a gap width J₂.

The machine 1 further comprises first determining means 11, second determining means 12 and third determining means 13.

The inductive position sensor 7, 8, the first determining means 11, the second determining means 12 and the third determining means 13 form a device for determining the expansion of the rotor 3.

The machine 1 may further comprise fourth determining means 10.

When the device for determining the expansion of the rotor 3 comprises the sensor 7 measuring the radial position of the rotor 3, the determining device determines the radial expansion Vdr of the rotor 3.

When the device for determining the expansion of the rotor 3 comprises the sensor 8 measuring the axial position of the rotor 3, the determining device determines the axial expansion Vda of the rotor 3.

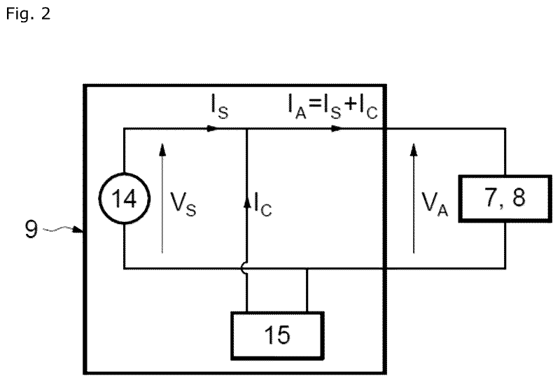

FIG. 2 schematically illustrates one example of the supply circuit 9.

The supply circuit 9 comprises an AC voltage source 14 connected to supply terminals of the inductive position sensor 7, 8.

The AC voltage source 14 delivers an AC supply current I_{S} and a voltage Vs having, for example, a sinusoidal waveform.

The inductive position sensor 7, 8 consumes a large amount of reactive power for which compensation must be made.

The supply circuit 9 comprises a reactive-power-compensating device 15 making it possible to compensate for the reactive power consumed by the inductive position sensor 7, 8.

The compensating device 15 is connected to the supply terminals of the inductive position sensor 7, 8.

The compensating device 15 generates a compensating current I_{C} such that the supply current I_{S} is in phase with the supply voltage V_{S}.

When the supply current I_{S} is in phase with the supply voltage V_{S}, the AC voltage source 14 does not deliver reactive power. The reactive power consumed by the inductive position sensor 7, 8 is compensated for by the device 15 generating the compensating current I_{C}.

The device 15 extracts or delivers the compensating current I_{C} to the supply terminals of the sensor 7, 8.

The extracted compensating current I_{C} is stored in an energy-storing device of the compensating device 15.

The delivered compensating current I_{C} is delivered from the energy-storing device of the compensating device 15.

The sensor 7, 8 is supplied with power by a global supply current I_{A} equal to the sum of the AC supply current I_{S} and of the compensating current I_{C}, and a global supply voltage V_{A}.

The value of the inductance of the sensor 7, 8 is inversely proportional to the value of the gap width separating the sensor 7, 8 from the rotor 3.

When the rotor 3 expands, the gap width separating the sensor 7, 8 from the rotor 3 varies so that the value of the inductance of the sensor 7, 8 varies.

The variation in the inductance of the sensor 7, 8 modifies the value of the global supply current I_{A} and of the global supply voltage V_{A}.

Since the value of the compensating current I_{C} depends on the value of the inductance of the sensor 7, 8, the variation in the value of the inductance of the sensor 7, 8 may be determined by observing the value of the compensating current I_{C}.

As a variant, the supply circuit 9 does not comprise the compensating device 15.

When the supply circuit 9 does not comprise the compensating device 15, the variation in the value of the inductance of the sensor 7, 8 may be determined by observing the value of the quadrature component I_{S_q} of the AC supply current I_{S} delivered by the AC voltage source 14. In this case, the global supply current I_{A} is equal to the supply current I_{S} delivered by the AC voltage source 14.

The quadrature component I_{S_q} of the supply current I_{S} is determined using known methods based on observation of the supply voltage V_{S} and of the supply current I_{S}.

Therefore, the value of the gap width separating the sensor 7, 8 from the rotor 3 may be determined based on the value of the compensating current I_{C} when the supply circuit 9 comprises the compensating device 15 or on the quadrature component I_{S_q} of the supply current I_{S} when the supply circuit 9 does not comprise the compensating device 15.

Let Vd be the value of the expansion of the rotor 3. The value of the expansion Vd of the rotor 3 may be the value of the radial expansion Vdr or the value of the axial expansion Vda.

The value of the expansion Vd is such that:

$$Vd = J ( t 0 ) - \frac{J ( t 0 ) {I}_{c} ( t 1 )}{{I}_{c} ( t 0 )}$$

where J(t0) is the value of a reference gap width, I_{C}(t0) is a reference value of the compensating current I_{C} and I_{C}(t1) is a present value of the compensating current I_{C}.

The value of the expansion Vd is such that:

$$Vd = J ( t 0 ) - \frac{J ( t 0 ) {I}_{S\_q} ( t 1 )}{{I}_{S\_q} ( t 0 )}$$

where I_{S_q}(t0) is a reference value of the quadrature component I_{S_q} of the supply current I_{S}, and I_{S_q}(t1) is a present value of the quadrature component I_{S_q} of the supply current I_{S}.

The reference value J(t0) of the gap width, the reference value I_{C}(t0) of the compensating current I_{C}, and the reference value I_{S_q}(t0) of the quadrature component I_{S_q} of the AC supply current I_{S} are determined in a calibrating phase following installation of the rotor 3 in the active magnetic bearings 4.

The present value J(t1) of the gap width, the present value I_{C}(t1) of the compensating current I_{C}, and the present value I_{S_q}(t1) of the quadrature component I_{S_q} of the AC supply current I_{S} are determined in a monitoring phase following at least one usage phase of the electric machine 1 as detailed below.

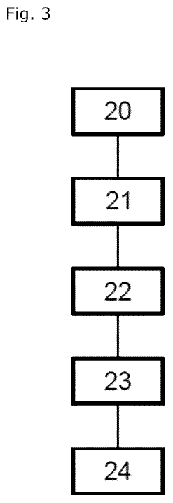

FIG. 3 illustrates one example of a method for determining the expansion Vd of the rotor 3.

It is assumed that in the example the method determines the radial expansion Vdr of the rotor 3 based on the measurements delivered by the inductive position sensor 7 measuring the radial position of the rotor 3.

The method employs the device for determining a coefficient of expansion of the rotor 3.

The calibrating phase following installation of the rotor 3 in the magnetic bearings 4 comprises a step 20.

During the step 20, the first determining means 11 determines a gap width J₁ separating the rotor 3 from the inductive position sensor 7 measuring the radial position of the rotor 3. The measured gap width is equal to the reference value of the gap width J(t0).

Furthermore, the second determining means 12 determines the value of a current representative of the power being supplied to the inductive position sensor 7 when the gap width separating the rotor 3 from said inductive position sensor 7 is equal to the reference value of the gap width J(t0).

The value of said current is a reference value of said current.

The current representative of the power being supplied to the inductive position sensor 7 comprises the compensating current I_{C} when the supply circuit 9 comprises the compensating device 15 or the supply current I_{S} when the supply circuit 9 does not comprise the compensating device 15.

When the current representative of the power being supplied to the inductive position sensor 7 comprises the compensating current I_{C}, the value of the compensating current I_{C} is determined from the current delivered by the device 15, for example by measuring the current delivered by the device 9. The value of the compensating current I_{C} determined in this step is equal to the reference value I_{C}(t0) of the compensating current I_{C}. The reference value of the current representative of the power being supplied to the inductive position sensor 7 is equal to said reference value I_{C}(t0).

When the current representative of the power being supplied to the inductive position sensor 7 comprises the supply current Is, the value of the quadrature component I_{S_q} of the AC supply current I_{S} delivered by the source 14 is determined.

The value of the quadrature component I_{S_q} of the AC supply current Is determined in this step is equal to the reference value I_{S_q}(t0) of the AC supply current I_{S}. The reference value of the current representative of the power being supplied to the inductive position sensor 7 is equal to said reference value I_{S_q}(t0).

The calibrating phase is followed by a phase 21 of using the electric machine 1, during which the machine 1 executes the task for which it was designed, for example to compress a fluid when the machine 1 is a motorized compressor.

The usage phase 21 is followed by a monitoring phase comprising two steps 22 and 23.

During step 22, the second determining means 12 determines the value of the current representative of the power being supplied to the inductive position sensor 7.

The value of the current representative of the power being supplied to the inductive position sensor 7 determined during this step is equal to a present value of said current.

When the current representative of the power being supplied to the inductive position sensor 7 comprises the compensating current I_{C}, the value of the compensating current I_{C} is determined from the current delivered by the device 15, for example by measuring the current delivered by the device 9. The value of the compensating current I_{C} determined in this step is equal to the present value I_{C}(t1) of the compensating current I_{C}. The present value of the current representative of the power being supplied to the inductive position sensor 7 is equal to said value I_{C}(t1).

When the current representative of the power being supplied to the inductive position sensor 7 comprises the supply current Is, the value of the quadrature component I_{S_q} of the AC supply current I_{S} is determined.

The value of the quadrature component I_{S_q} of the AC supply current Is determined in this step is equal to the present value I_{S_q}(t1) of the AC supply current I_{S}. The present value of the current representative of the power being supplied to the inductive position sensor 7 is equal to said value I_{S_q}(t1).

In step 23, the third determining means 13 determines the value of the radial expansion Vdr of the rotor 3 based on the reference value of the current representative of the power being supplied to the inductive position sensor 7 and on the reference value of the gap width J(t0) determined in step 20, on the present value of said current determined in step 22 and on one of Equations (1) and (2).

When the current representative of the power being supplied to the inductive position sensor 7 comprises the compensating current I_{C}, the value of the radial expansion Vdr of the rotor 3 is determined based on the reference value I_{C}(t0) of the compensating current I_{C}, on the reference value I_{C}(t1) of said current, on the reference value of the gap width J(t0) and on Equation (1).

When the current representative of the power being supplied to the inductive position sensor 7 comprises the supply current Is, the value of the radial expansion Vdr of the rotor 3 is determined based on the reference value I_{S_q}(t0), on the present value I_{S_q}(t1), on the reference value of the gap width J(t0) and on Equation (2).

When the value of the expansion of the rotor has been determined and the machine 1 comprises the fourth determining means 10, during a step 24, the fourth determining means 10 determines the present value of the gap width J(t1) equal to the difference between the reference value of the gap width J(t0) and the value of the expansion of the rotor 3.

The present value of the gap width J(t1) makes it possible to adjust alert thresholds in real time so that the distance between the radial magnetic bearings 4 and the rotor 3 is decreased while flagging a probable collision if said distance is less than said thresholds.

Of course, usage phases may be alternated with monitoring phases, the usage phases being the duration of operation of the machine 1 or some segment of the duration of operation of the machine 1.

As a variant, in the example the method determines the axial expansion Vda of the rotor 3 based on the measurements delivered by the inductive position sensor 8 measuring the axial position of the rotor 3.

During step 20, the first determining means 11 determines a gap width J₂ separating the rotor 3 from the inductive position sensor 8 measuring the axial position of the rotor 3. The measured gap width is equal to the reference value of the gap width J(t0) and the second determining means 12 determines the value of a current representative of the power being supplied to the inductive position sensor 8 when the gap width separating the rotor 3 from said inductive position sensor 8 is equal to the reference value of the gap width J(t0).

During step 22, the second determining means 12 determines the value of the current representative of the power being supplied to the inductive position sensor 8.

In step 23, the third determining means 13 determines the value of the axial expansion Vda of the rotor 3 based on the reference value of the current representative of the power being supplied to the inductive position sensor 8 and on the reference value of the gap width J(t0) determined in step 20, and on the present value of said current determined in step 22.

When the current representative of the power being supplied to the inductive position sensor 8 comprises the compensating current I_{C}, the value of the axial expansion Vda of the rotor 3 is determined based on the reference value I_{C}(t0) of the compensating current I_{C}, on the reference value I_{C}(t1) of said current, on the reference value of the gap width J(t0) and on Equation (1).

When the current representative of the power being supplied to the inductive position sensor 8 comprises the supply current Is, the value of the axial expansion Vda of the rotor 3 is determined based on the reference value I_{S_q}(t0), on the present value I_{S_q}(t1), on the reference value of the gap width J(t0) and on Equation (2).

According to another variant, the method simultaneously determines the radial and axial expansion values based on the measurements delivered by the inductive position sensor 7 measuring the radial position of the rotor 3 and by the inductive position sensor 8 measuring the axial position of the rotor 3.

The method for determining the expansion allows the value of the axial or radial expansion of the rotor 3 to be determined without addition of position sensors and of means for processing the signals delivered by said sensors dedicated to determining said value.

The method for determining the expansion of the rotor 3 employs an inductive position sensor, which is already present in the machine 1 to control the magnetic bearings 4, to determine the value of the expansion of the rotor 3.

1. A method for determining, using an inductive position sensor, the expansion of a rotor of an electric machine, the rotor being supported by at least one magnetic bearing, the inductive position sensor measuring the position of the rotor, the method comprising:
in a calibrating phase following installation of the rotor in the magnetic bearing:
determining a gap width separating the rotor from said inductive position sensor, said gap width being equal to a reference value of the gap width, and
determining the value of a current representative of the power being supplied to the inductive position sensor when the gap width separating the rotor from said inductive position sensor is equal to the reference value of the gap width, the value of said current being a reference value of said current,
in a monitoring phase following at least one usage phase of the electric machine:
determining the present value of said current,
determining the value of the expansion of the rotor based on the reference value of said current, on the present value of said current and on the reference value of the gap width.

2. The method according to claim 1, wherein the value of the expansion of the rotor is equal to the value of a radial expansion of the rotor, the inductive position sensor measuring the radial position of the rotor.

3. The method according to claim 1, wherein the value of the expansion of the rotor is equal to the value of an axial expansion of the rotor, the inductive position sensor measuring the axial position of the rotor.

4. The method according to claim 1, wherein the current representative of the power being supplied to the inductive position sensor comprises a reactive-power-compensating current delivered by a compensating device, the reactive-power-compensating current being supplied to the inductive position sensor to compensate for the reactive power consumed by the position sensor, the determination of the value of the expansion of the rotor comprising determining the reactive-power-compensating current, the value of the expansion (Vd) of the rotor being determined using the following equation:
$$\underline{Vd = J ( t 0 ) - \frac{J ( t 0 ) {I}_{c} ( t 1 )}{{I}_{c} ( t 0 )}}$$
where J(t0) is the reference value of the gap width, I_{C}(t0) is the reference value of the compensating current and I_{C}(t1) is the present value of the compensating current.

5. The method according to claim 1, wherein the sensor is supplied with an AC supply current delivered by an AC voltage source, the current representative of the power being supplied to the inductive position sensor comprising the quadrature component of the AC supply current, the determination of the value of the expansion of the rotor comprising determining the quadrature component of the AC supply current, the value of the expansion (Vd) of the rotor being determined using the following equation:
$$Vd = J ( t 0 ) - \frac{J ( t 0 ) {I}_{S\_q} ( t 1 )}{{I}_{S\_q} ( t 0 )}$$
where J(t0) is the reference value of the gap width, I_{A_q}(t0) is the reference value of the quadrature component of the AC supply current and I_{S_q}(t1) is the present value of the quadrature component of the AC supply current.

6. The method according to claim 2, wherein the current representative of the power being supplied to the inductive position sensor comprises a reactive-power-compensating current delivered by a compensating device, the reactive-power-compensating current being supplied to the inductive position sensor to compensate for the reactive power consumed by the position sensor, the determination of the value of the expansion of the rotor comprising determining the reactive-power-compensating current, the value of the expansion (Vd) of the rotor being determined using the following equation:
$$\underline{Vd = J ( t 0 ) - \frac{J ( t 0 ) {I}_{c} ( t 1 )}{{I}_{c} ( t 0 )}}$$
where J(t0) is the reference value of the gap width, I_{C}(t0) is the reference value of the compensating current and I_{C}(t1) is the present value of the compensating current.

7. The method according to claim 6, wherein the sensor is supplied with an AC supply current delivered by an AC voltage source, the current representative of the power being supplied to the inductive position sensor comprising the quadrature component of the AC supply current, the determination of the value of the expansion of the rotor comprising determining the quadrature component of the AC supply current, the value of the expansion (Vd) of the rotor being determined using the following equation:
$$Vd = J ( t 0 ) - \frac{J ( t 0 ) {I}_{S\_q} ( t 1 )}{{I}_{S\_q} ( t 0 )}$$
where J(t0) is the reference value of the gap width, I_{A_q}(t0) is the reference value of the quadrature component of the AC supply current and I_{S_q}(t1) is the present value of the quadrature component of the AC supply current.

8. A device for determining expansion of a rotor of an electric machine, the rotor being supported by at least one magnetic bearing, the device comprising:
an inductive position sensor measuring a position of the rotor,
first determining means configured to determine a gap width separating the rotor from said inductive position sensor, said gap width being equal to a reference value of the gap width in a calibrating phase following installation of the rotor in the magnetic bearing,
second determining means configured to determine the value of a current representative of the power being supplied to the inductive position sensor when the gap width separating the rotor from said inductive position sensor is equal to the reference value of the gap width, the value of said current being a reference value of said current in the calibrating phase following installation of the rotor in the magnetic bearing, and to determine the value of the current representative of the power being supplied to the inductive position sensor in a monitoring phase following at least one usage phase of the electric machine, and
third determining means configured to determine the value of the expansion of the rotor based on the reference value of said current, on the present value of said current and on the value of the gap width.

9. The device according to claim 8, wherein the inductive position sensor is an inductive radial-position sensor configured to measure the radial position of the rotor, the value of the expansion of the rotor being equal to the value of a radial expansion of the rotor.

10. The device according to claim 8, wherein the inductive position sensor is an inductive axial-position sensor configured to measure the axial position of the rotor, the value of the expansion of the rotor being equal to the value of an axial expansion of the rotor.

11. The device according to claim 8, wherein the current representative of the power being supplied to the inductive position sensor comprises a reactive-power-compensating current delivered by a compensating device, the reactive-power-compensating current being supplied to the inductive position sensor to compensate for the reactive power consumed by the position sensor, the second determining means being configured to determine the reference value of the compensating current in the calibrating phase, and to determine the value of the compensating current in the monitoring phase, and the third determining means being configured to determine the value of the expansion (Vd) of the rotor using the following equation:
$$\underline{Vd = J ( t 0 ) - \frac{J ( t 0 ) {I}_{c} ( t 1 )}{{I}_{c} ( t 0 )}}$$
where J(t0) is the reference value of the gap width, I_{C}(t0) is the reference value of the compensating current and I_{C}(t1) is the present value of the compensating current.

12. The device according to claim 8, wherein the sensor is supplied with an AC supply current delivered by an AC voltage source, the current representative of the power being supplied to the inductive position sensor comprising the quadrature component of the AC supply current, the second determining means being configured to determine the reference value of the quadrature component of the AC supply current in the calibrating phase, and to determine the quadrature component of the AC supply current in the monitoring phase, and the third determining means being configured to determine the value of the expansion (Vd) of the rotor using the following equation:
$$Vd = J ( t 0 ) - \frac{J ( t 0 ) {I}_{S\_q} ( t 1 )}{{I}_{S\_q} ( t 0 )}$$
where J(t0) is the reference value of the gap width, I_{S_q}(t0) is the reference value of the quadrature component of the AC supply current and I_{S_q}(t1) is the present value of the quadrature component of the AC supply current.

13. The device according to claim 10, wherein the current representative of the power being supplied to the inductive position sensor comprises a reactive-power-compensating current delivered by a compensating device, the reactive-power-compensating current being supplied to the inductive position sensor to compensate for the reactive power consumed by the position sensor, the second determining means being configured to determine the reference value of the compensating current in the calibrating phase, and to determine the value of the compensating current in the monitoring phase, and the third determining means being configured to determine the value of the expansion (Vd) of the rotor using the following equation:
$$\underline{Vd = J ( t 0 ) - \frac{J ( t 0 ) {I}_{c} ( t 1 )}{{I}_{c} ( t 0 )}}$$
where J(t0) is the reference value of the gap width, I_{C}(t0) is the reference value of the compensating current and I_{C}(t1) is the present value of the compensating current.

14. The device according to claim 13, wherein the sensor is supplied with an AC supply current delivered by an AC voltage source, the current representative of the power being supplied to the inductive position sensor comprising the quadrature component of the AC supply current, the second determining means being configured to determine the reference value of the quadrature component of the AC supply current in the calibrating phase, and to determine the quadrature component of the AC supply current in the monitoring phase, and the third determining means being configured to determine the value of the expansion (Vd) of the rotor using the following equation:
$$Vd = J ( t 0 ) - \frac{J ( t 0 ) {I}_{S\_q} ( t 1 )}{{I}_{S\_q} ( t 0 )}$$
where J(t0) is the reference value of the gap width, I_{S_q}(t0) is the reference value of the quadrature component of the AC supply current and I_{S_q}(t1) is the present value of the quadrature component of the AC supply current.
